(19) United States
(12) Patent Application Publication
(10) Pub. No.: US 2015/0193102 A1
(43) Pub. Date: Jul. 9, 2015

(54) MULTI-MODE DISPLAY SYSTEM

(71) Applicant: Microsoft Corporation, Redmond, WA (US)

(72) Inventors: Jaron Lanier, Berkeley, CA (US); Joel S. Kollin, Seattle, WA (US); William T. Blank, Bellevue, WA (US); Doug Burger, Bellevue, WA (US); Patrick Therien, Bothell, WA (US); Jason L. Waskey, Seattle, WA (US); Ian Wood, Kenmore, WA (US); Raymond W. Riley, Bainbridge Island, WA (US)

(73) Assignee: Microsoft Corporation, Redmond, WA (US)

(21) Appl. No.: 14/150,642

(22) Filed: Jan. 8, 2014

(51) Int. Cl. G06F 3/0484; G06F 3/01

(52) U.S. Cl. CPC G06F 3/0484; G06F 3/017

(57) ABSTRACT

Embodiments relating to a wearable multi-mode display system actuatable by a wrist or hand are disclosed. For example, in one disclosed embodiment a first compact image is displayed in a first display mode via a display device, with the first compact image having a display resolution corresponding to a first application. While in the first display mode, a principal user input is received from the user's wrist or hand. In response, a second, different compact image is displayed. When the device is less than a predetermined distance from the user, an application image is displayed in a second display mode, with the application image having a greater display resolution. While in the second display mode, a secondary user input is received from the user's wrist or hand. In response, a graphical user interface element is controlled within the application image.

### BACKGROUND

Users of mobile devices such as smartphones desire maximum convenience and usability in their devices. Various design elements of these devices may be adjusted to enhance their convenience and usability. For example, portability of a device may be emphasized by minimizing a size and weight of the device. Easy and quick user access to the device may be provided via particular form factors, such as a head-mounted display (HMD) or other near eye display device. On the other hand, users also want their devices to deliver a rich, high quality media experience, such as generating high resolution images and providing robust user interaction features.

In some example attempts to improve device usability, smartphone screens have utilized increasing pixel densities and larger display areas. However, such larger devices may negatively impact portability and other usability and convenience criteria. Some devices have incorporated user-interface functionality such as pinch zooming/scrolling to provide enhanced interaction possibilities. However, such approaches utilize one hand of a user to hold the device and the other hand to interact with the device, making such interactions more complex and lessening the overall convenience of such devices.

While an HMD device enables the wearer to immediately access the device display, such a device is not without its shortcomings. For example, some users dislike their appearance when wearing an HMD device. Further, because HMD devices are constantly in position and potentially capturing data, concerns related to third party privacy may also arise.

### SUMMARY

Various embodiments are disclosed herein that relate to a wearable multi-mode display system that is actuatable by a wrist or hand of a user. For example, one disclosed embodiment provides a multi-mode display system comprising a display device that is operatively connected to a computing device. The display device includes a display stack comprising a principal image display system and a secondary image display system. The principal image display system includes a display screen configured to display a first compact image in a first display mode, with the first compact image comprising a first display resolution corresponding to a first application. The secondary image display system is configured to display an application image in a second display mode when the display device is detected to be less than a predetermined distance from a user. The application image has a second, greater display resolution corresponding to the first application.

A display mode program is executed by a processor of the computing device. The display mode program is configured to receive a principal user input from the wrist or hand of the user when the display device is in the first display mode. In response to the principal user input, the program is configured to display a second, different compact image instead of the first compact image. The program is also configured to receive a secondary user input from the wrist or hand of the user when the display device is in the second display mode. In response to the secondary user input, the program is configured to control a graphical user interface element displayed in the application image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of a wearable multi-mode display system according to an embodiment of the present disclosure.

FIG. 2 is a schematic view of a user viewing an embodiment of a wearable multi-mode display system at a first distance from the user.

FIG. 3 is a schematic view of a user viewing the embodiment of the wearable multi-mode display system of FIG. 2 at a second, different distance from the user.

FIG. 4 is a schematic view of an example compact image and corresponding application image.

FIG. 5 is a schematic view of another example compact image and corresponding application image.

FIG. 6 is a schematic view of another example compact image and corresponding application image.

FIG. 7 is a schematic view of an embodiment of a display stack that includes a principal image display system and a secondary image display system.

FIG. 8 is a schematic view of a wristwatch embodiment of a wearable multi-mode display system.

FIG. 9 is a schematic side view of a user's hand and wrist wearing the wristwatch embodiment of FIG. 8.

FIG. 10 is a schematic top view of the user's hand and wrist wearing the wristwatch embodiment of FIG. 8.

FIGS. 11-15 are schematic views of various embodiments of form factors for a wearable multi-mode display system.

FIGS. 16A and 16B are a flow chart of a multi-mode display method according to an embodiment of the present disclosure.

FIG. 17 a simplified schematic illustration of an embodiment of a computing device.

### DETAILED DESCRIPTION

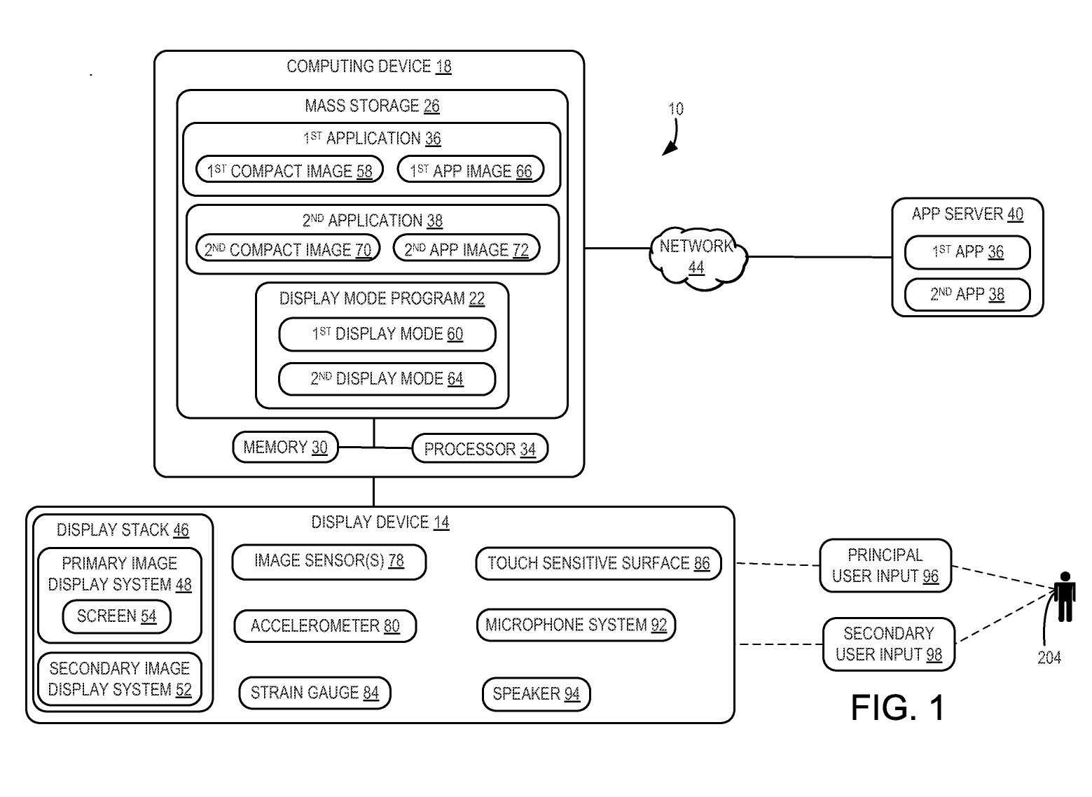

FIG. 1 shows a schematic view of one embodiment of a wearable multi-mode display system 10 according to an embodiment of the present disclosure. The wearable multi-mode display system 10 comprises a display device 14 that is operatively connected to a computing device 18. In some examples and as described in more detail below, the display device 14 may be embedded in a wearable design or other compact form factor that enables single-handed input by a user. Additionally and depending upon a proximity of the display device 14 from the eye of the user, the display device may be configured to show a first number of pixels at a first display resolution, or a second number of pixels at a second display resolution.

For example, when located at a first distance from the user, the display device 14 may provide a first, relatively lower display resolution that conveys a summary version of visual information corresponding to an application. When a user moves the display device 14 to a second, smaller distance from the user, the display device 14 may provide a second, higher display resolution that comprises a second, greater amount of visual information corresponding to the application. Additionally and as described in more detail below, the display device 14 may be configured to enable the user to navigate both the lower resolution and the higher resolution images by providing input with a single wrist and/or hand of the user. In some examples, the single hand providing the input may be the same hand with which the display device is being held, or may be the hand that extends from the user's wrist to which the display device is removably secured. In other examples, the wrist providing the input may be the user's wrist to which the display device is removably secured.

Returning to FIG. 1, as noted above the display device 14 is operatively connected to a computing device 18. The computing device 18 includes a display mode program 22 that may be stored in mass storage 26. The display mode program 22 may be loaded into memory 30 and executed by a processor 34 of the computing device 18 to perform one or more of the methods and processes described in more detail below.

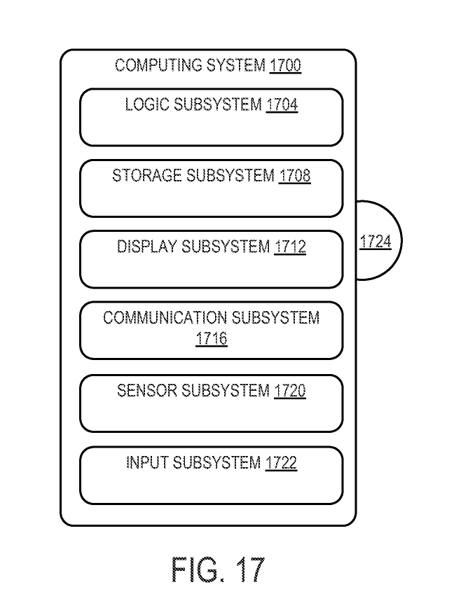

The mass storage 26 may further include a first application 36 and a second application 38. In some examples the first application 36 and/or second application 38 may be located on an application server 40 and accessed by the computing device via a network 44. The network 44 may take the form of a local area network (LAN), wide area network (WAN), wired network, wireless network, personal area network, or a combination thereof, and may include the Internet. It will also be appreciated that the wearable multi-mode display system 10 may be operatively connected with other computing devices via network 44. Additional details regarding the components and computing aspects of the wearable multi-mode display system 10 are described in more detail below with reference to FIG. 17.

As mentioned above, users of mobile computing devices desire maximum convenience along with high quality and rich media experiences. For example, users would like easy and quick access to the full capabilities and user experience of an application, while also avoiding typical form factor related inconveniences, such as reaching in a pocket for a mobile device, donning reading glasses to comfortably view smaller visuals, or reverse-pinching and scrolling to view and navigate information. Further and as noted above, continually wearing an HMD device may not be acceptable to some users, and may cause social tension arising from third party privacy concerns.

To address one or more of these drawbacks, in one example the display device 14 of the wearable multi-mode display system 10 may include a display stack 46 comprising a principal image display system 48 and a secondary image display system 52. As explained in more detail below with respect to example embodiments of the wearable multi-mode display system 10, the principal image display system 48 may include a display screen 54 that is configured to display a first compact image 58 in a first display mode 60, wherein the first compact image is displayed in a first display resolution that corresponds to the first application 36.

When a user brings the display device 14 closer to the user's eyes to a position less than a predetermined distance from the user, the display mode program 22 may be configured to switch between the first display mode 60 and a second display mode 64. In the second display mode 64, the principal image display system 48 is deactivated and the secondary image display system 52 is activated to display a first application image 66 that has a second, greater display resolution (as compared to the first compact image 58) and that also corresponds to the first application 36. Advantageously and as explained in more detail below, in this manner the wearable multi-mode display system 10 facilitates quick and convenient user access to and navigation among varying amounts of visual information corresponding to an application.

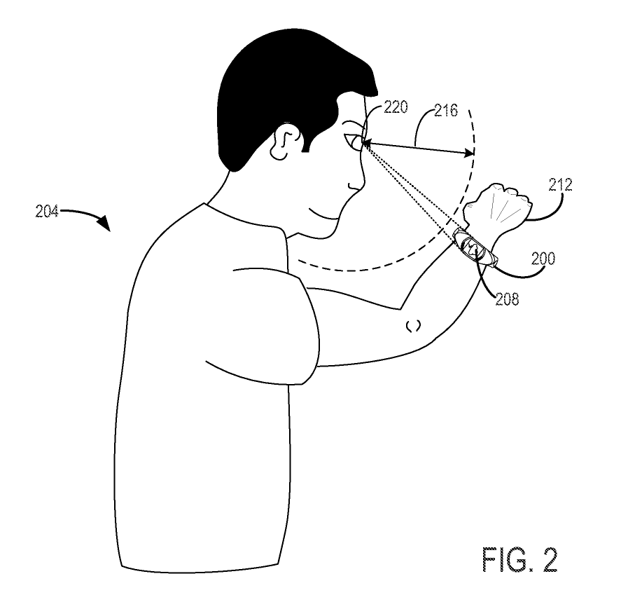

With reference now to FIGS. 2-4, in one example the wearable multi-mode display system 10 may take the form factor of a wristwatch 200 that is removably attachable to a wrist area adjacent to a hand 212 of user 204. As shown in FIG. 2, when the wristwatch 200 is detected to be more than a predetermined distance 216 from an eye 220 of the user 204, the first display mode 60 is engaged. In some examples the predetermined distance may be between approximately 20 millimeters (mm) and approximately 180 mm, between approximately 40 mm and approximately 160 mm, between approximately 60 mm and approximately 140 mm, between approximately 80 mm and approximately 120 mm, or may be approximately 100 mm. In some examples, there may be hysteresis, so that the image mode once triggered remains stable until the distance exceeds the other end of the distance range.

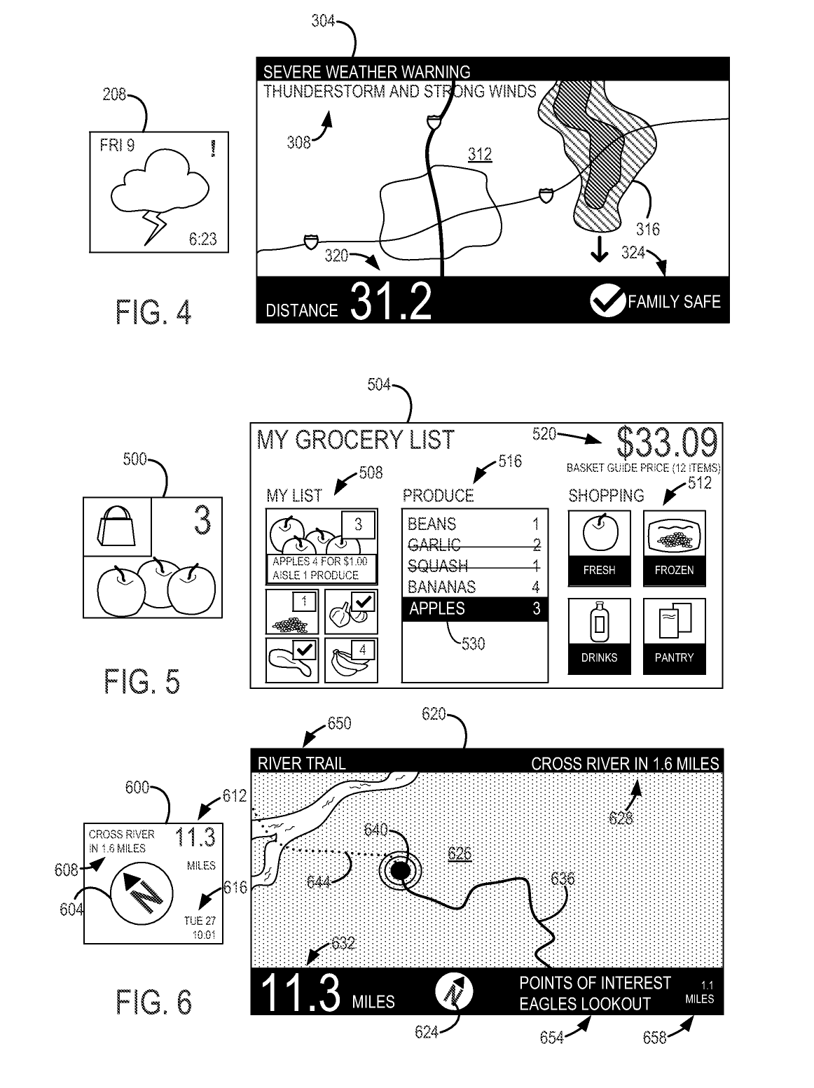

In this example, the first display mode 60 corresponds to a display screen of the wristwatch 200 displaying a weather compact image 208 that corresponds to a weather application providing a severe weather warning. As shown in the example of FIG. 4, the weather compact image 208 has a first display resolution that presents a quickly recognizable icon of a thundercloud and lightning bolt along with an exclamation point. Advantageously, with a mere glance at his wristwatch 200, the user 204 can promptly discern the weather warning imagery and thereby determine that a severe weather event may be imminent. It will also be appreciated that the particular icons, text, layouts, and other design elements described for the weather compact image 208 and for the other compact images and application images described herein are provided as mere examples, and that any suitable content and design of compact images and applications images may be utilized.

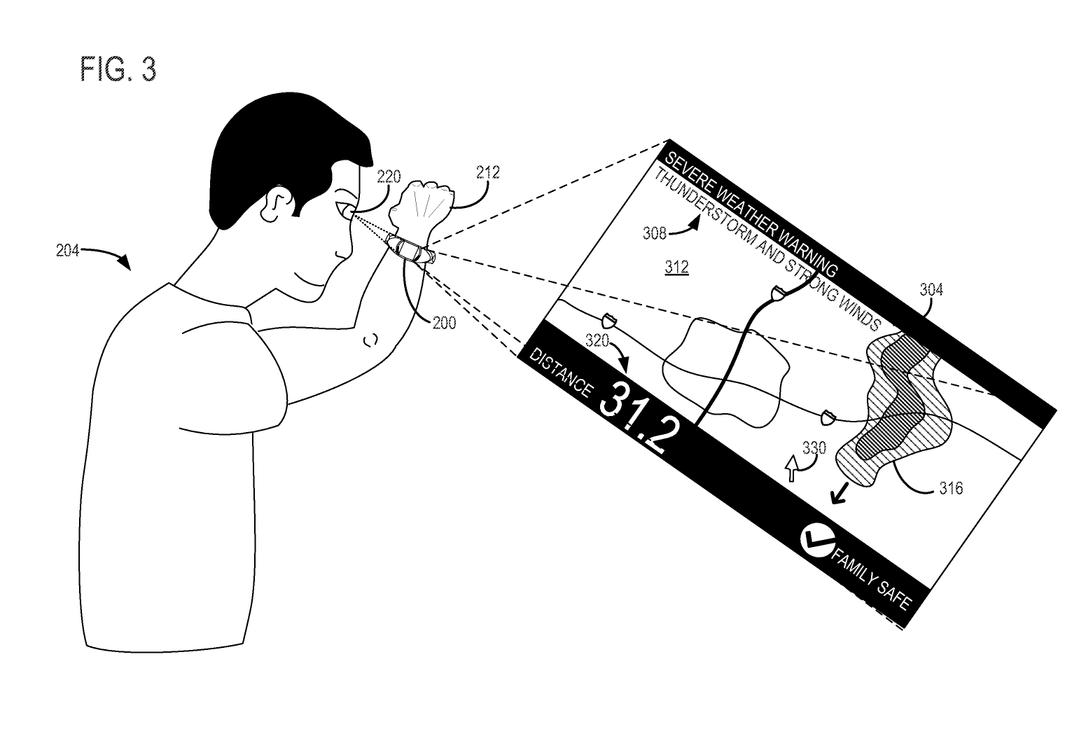

With reference now to FIG. 3 and to quickly obtain additional information regarding the weather event, the user 204 may raise his hand 212 and wristwatch 200 closer to his eyes 220 such that the wristwatch is less than the predetermined distance from the user's eyes. As noted above, when the wristwatch 200 is detected to be less than the predetermined distance from the user's eye 220, the display mode program 22 triggers the second display mode 64. In this example, the second display mode 60 corresponds to a secondary image display system 52 of the wristwatch 200 displaying a weather application image 304 at a perceived distance from the user 204. Additional details regarding the secondary image display system 52 are provided below.

As shown in FIGS. 3 and 4, the weather application image 304 has a second display resolution that presents a greater amount of visual information corresponding to the weather application than the first display resolution of the weather compact image 208. In the example of FIGS. 3 and 4, and as explained in more detail below, the weather application image 304 includes a weather detail region 308 that notes that the warning relates to a thunderstorm and strong winds, a map region 312 that includes a radar image of a storm 316, a distance region 320 indicating a distance of the storm 316 from the user's current location, and a family status region 324 providing a status update regarding the user's family. Advantageously, the weather application image 304 provides the user 204 with a quickly and conveniently accessible, high resolution image that provides a large-screen user experience containing significant visual information.

With reference again to FIG. 1, a second application 68 and corresponding second compact image 70 and second application image 72 may be stored in mass storage 26 and/or located on the application server 40. With reference now to FIG. 5 and in one example, the second application 68 may comprise a shopping application that includes a shopping compact image 500 and a shopping application image 504. In the example of FIG. 5, the shopping compact image 500 may include an image of apples and the number 3 indicating that the user 204 has 3 apples on his grocery list.

The shopping application image 504 may include a list region 508 that comprises a list of grocery items with corresponding quantities. In one example, the list region 508 includes an image of apples and the number 3, along with a notification indicating that apples are on sale for 4 for $1.00 and may be found on aisle 1 in the Produce section of the store. A check mark may indicate that an item on the list has been procured. The shopping application image 504 may also include a category region 512 that comprises different categories of items to be procured. When one of the categories is selected, the items from that category may be displayed in the list region 508 and a category detail region 516. The shopping application image 504 may further include a basket price region 520 that displays a total running price and number of items that have been procured by the user.

With reference now to FIG. 6 and in another example, a navigation compact image 600 and navigation application image 620 that each correspond to a navigation application may be displayed via the wristwatch 200. In one example the navigation compact image 600 may include a compass image 604 indicating true or magnetic North, a next action region 608 indicating an upcoming navigation action, a distance region 612 indicting a distance to a destination, and a time and date region 616.

Similar to the navigation compact image 600, the navigation application image 620 may include a compass image 624, a next action region 628, and a distance region 632. Additionally, the navigation application image 620 may further include a map 626 showing a previously traveled route 636, a current location 640 and a suggested route 644. The navigation application image 620 may further include a trip title region 650 and a point of interest region 654 and adjacent distance region 658 indicating a distance to the point of interest.

As shown in FIGS. 2 and 3 and with reference also to FIGS. 4-6, each of the compact images may occupy the substantial entirety of the wristwatch display screen. In this manner, the wearable multi-mode display system 10 may utilize a compact form factor display device that provides easily accessible and quickly identifiable visual information to a user.

It will also be appreciated that the above examples of applications and corresponding compact images and application images are provided for illustrative purposes, and are not to be considered limiting in any manner. Many other applications and corresponding compact images and application images may be utilized within the scope of the present disclosure. For example, a home security application may utilize a compact image that provides a summary indication of a security status of a user's home. A corresponding application image may provide more details regarding the security status, such as a rendering of the user's home, alarm system status, door lock status, etc.

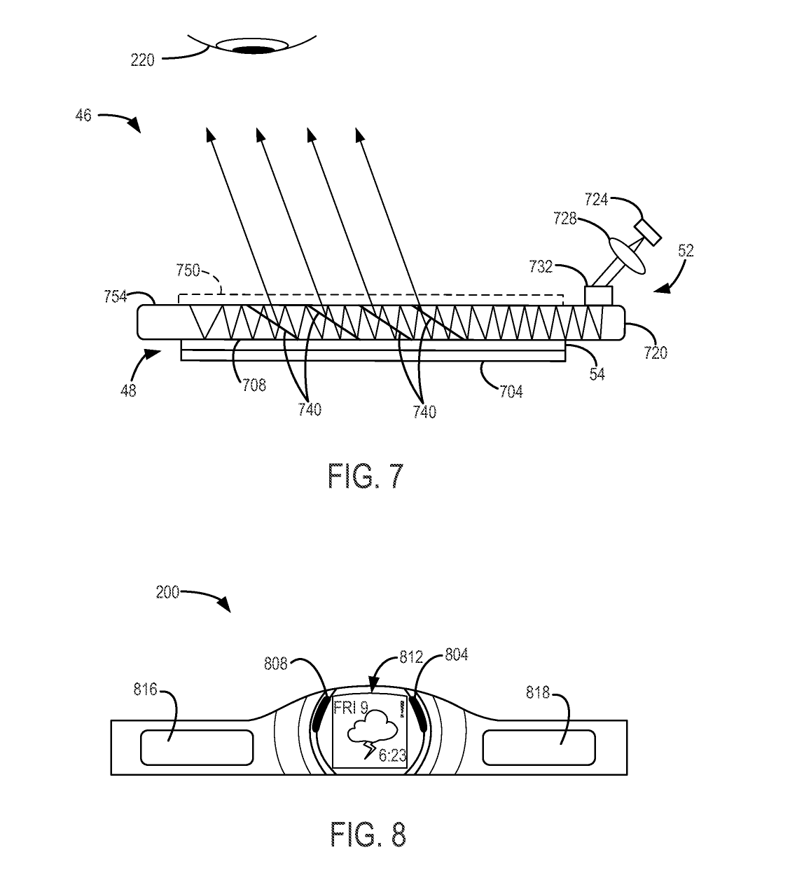

With reference now to FIG. 7, a schematic representation of an example display stack 46 of display device 14 is provided. The display stack 46 includes the principal image display system 48 and the secondary image display system 52. In the example of FIG. 7, the display stack 46 comprises a layered configuration in which a first display technology for the principal image display system 48 and a second, different display technology for the secondary image display system 52 are utilized in a sandwiched configuration.

In some examples, the principal image display system 48 may comprise a diffusive display such as a luminescent or reflective liquid crystal display (LCD), or any other suitable display technology. The principal image display system 48 may comprise an innermost layer of the display stack 46, and may include a display screen 54 positioned on a light emitting component 704. As noted above, the principal image display system 48 may be configured to display one or more compact images via the display screen 54.

The secondary image display system 52 is positioned on the light emitting side 708 of the principal image display system 48. As noted above and shown in FIG. 3, the secondary image display system 52 is configured to display images at a perceived distance behind the display stack 46 as viewed from the user's eye 220. In one example, the secondary image display system 52 may comprise a side addressed transparent display that enables a near-eye viewing mode. In such a near-eye display system, the user perceives a much larger, more immersive image as compared to an image displayed at the display screen 54 of the principal image display system 48.

As shown in FIG. 7, in some examples the secondary image display system 52 may comprise an optical waveguide structure 720. A micro-projector 724, such as one incorporating a liquid crystal on silicon (LCoS) display, may project light rays comprising an image through a collimator 728 and entrance grating 732 into the waveguide structure 720. In one example, partially reflective surfaces 740 located within the waveguide structure 720 may reflect light rays outwardly from the structure and toward the user's eye 220. In another example, and instead of the partially reflective surfaces 740 within the waveguide structure 720, a partially reflective exit grating 750 that transmits light rays outwardly from the waveguide structure 720 toward the user's eye 220 may be provided on a light emitting side 754 of the waveguide structure 720.

Additionally, the waveguide structure 720 and exit grating(s) may embody a measure of transparency which enables light emitted from the principal image display system 48 to travel through the waveguide structure and exit grating(s) when the micro-projector 724 is deactivated (such as when the first display mode 60 is active). Advantageously, this configuration makes two displays and two display resolutions available to the user through the same physical window.

In other examples, a display stack having a sandwiched configuration may include a lower resolution, principal image display system on a top layer of the stack and a higher resolution, secondary image display system on a bottom layer of the stack. In this configuration, the principal image display system is transparent to provide visibility to the secondary image display system through the stack. In some examples, the principal image display system may comprise a transparent OLED display or any other suitable transparent display technology.

As noted above, when the display device 14 and display stack 46 are greater than a predetermined distance from the user, the first display mode 60 may be utilized in which the principal image display system 48 is activated and the secondary image display system 52 is deactivated. In the first display mode 60 and with reference to the example display stack 46 of FIG. 7, the principal image display system 48 may display a compact image via display screen 54 that is viewable through the transparent and deactivated secondary image display system 52. When a user brings the display device 14 and display stack 46 to a position less than the predetermined distance from the user, the display mode program 22 may switch between the first display mode 60 and the second display mode 64. More particularly, the display mode program 22 may deactivate the principal image display system 48 and activate the secondary image display system 52.

It will also be appreciated that the secondary image display system 52 described herein is provided for example purposes, and that other suitable near-eye imaging modes, technologies and related components including, but not limited to, folded optical systems utilizing single fold, double fold, and triple fold optical paths, may be utilized.

With reference now to FIGS. 1 and 8, it will be appreciated that the display device 14 and computing device 18 may be integrated into the wristwatch 200. Additionally, the multi-mode display system 10 may further comprise one or more sensors and related systems located on or in the wristwatch 200. For example, the display device 14 may include one or more image sensor(s) 78 utilized to sense ambient light. With reference to the wristwatch 200 shown in FIG. 8, in this example the one or more image sensors 78 may be located in sensor regions 804 and/or 808 surrounding the display area 812 of the wristwatch.

The display device 14 may also include an accelerometer 80 that measures acceleration of the display device 14. In some examples, data from the accelerometer 80 and data from the image sensor(s) 78 may be used to determine a distance between the wristwatch 200 and the eye 220 of the user 204. For example, as the user 204 raises his wrist to bring the wristwatch 200 closer to his eye 220, the accelerometer may detect a signature acceleration that is associated with such movement. Additionally, as the wristwatch 200 and image sensor(s) 78 move closer to the user's eye 220 and face, the ambient light detected by the image sensor(s) may correspondingly decrease. For example, when the wristwatch 200 is located less than the predetermined distance from the user's eye 220, the ambient light detected by the image sensor(s) may be less than a predetermined percentage of the overall ambient light of the surrounding environment.

Accordingly, when the accelerometer 80 detects the signature acceleration of the wristwatch 200 and the image sensor(s) 78 detect that the ambient light level decreases below the predetermined percentage, the display mode program 22 may determine that the wristwatch 200 has been moved to a position that is less than the predetermined distance from the user's eye 220. Alternatively expressed, when the combination of a signature acceleration and an ambient light level decreasing below a predetermined percentage is determined to exist, the wristwatch 200 may be determined to have been moved to a position that is less than the predetermined distance from the user's eye 220. As described above, the display mode program 22 may then switch between the first display mode 60 and the second display mode 64.

In some examples, a temporal relationship of these two conditions may also be utilized. An example of such temporal relationship may be that each condition is satisfied within a predetermined time period such as, for example, 1.0 seconds, as a further condition of determining that the wristwatch 200 has been moved to a position that is less than the predetermined distance from the user's eye 220. It will also be understood that the above-described methods of detecting a distance between the wristwatch 220 and the user 204 are presented for the purpose of example, and are not intended to be limiting in any manner.

In other examples, the display device 14 may include an inertial measurement unit (IMU) that utilizes the accelerometer 80 and one or more other sensors to capture position data and thereby enable motion detection, position tracking and/or orientation sensing of the display device. It will be appreciated that any suitable configuration of motion sensing components may be utilized in an IMU. In some examples, IMU may also support other suitable positioning techniques, such as GPS or other global navigation systems.

The display device 14 may also include a strain gauge 84 that may measure the strain, bend and/or shape of a wrist band associated with the display device. In the example wristwatch 200 shown in FIG. 8, the strain gauge 84 may be located in one or both band portions 816 and 818. In some examples, the strain gauge 84 may comprise a metallic foil pattern supported by an insulated flexible backing. As the user 204 moves and/or flexes his hand 212, the band portions 816, 818 and integrated foil pattern are deformed, causing the foil's electrical resistance to change. This resistance change is measured and a corresponding strain exerted on the band portions 816, 818 may be determined.

Advantageously and as explained in more detail below, the strain gauge 84 may be utilized to detect one or more motions of the user's hand 212 and correspondingly receive user input. For example, hand movement side-to-side or up and down may be sensed via the corresponding tensioning and relaxation of particular tendons within the wrist area . In some examples, changes in the overall circumference of the user's wrist may be detected to determine when the user is making a fist. Each of these movements may be correlated to a particular user input instruction related to a compact image or an application image. It will also be appreciated that any suitable configuration of strain gauge 84 may be utilized with the wristwatch 200 or other display device 14.

The display device 14 may also include one or more touch-sensitive surface(s) 86 that may receive user touch input. The touch-sensitive surface(s) 86 may utilize, for example, capacitive sensing components, resistive sensing components, or any other suitable tactile sensing components that are sensitive to touch, force, and/or pressure. In the example wristwatch 200 shown in FIG. 8, the touch-sensitive surface(s) 86 may be located in one or both band portions 816, 818, one or both sensor regions 804, 808, or in other suitable locations. Advantageously and as explained in more detail below, the touch-sensitive surface(s) 86 may be utilized to detect user input corresponding to one or more touch inputs from a user's hand or other portions of a user's face, head or body. In some examples, the touch-sensitive surface(s) 86 may also detect contact with a user's clothing or other object.

In some examples the display device 14 may also include a gaze tracking system that includes one or more image sensors configured to acquire image data in the form of gaze tracking data from the user's eyes. Provided the user has consented to the acquisition and use of this information, the gaze tracking system may use this information to track a position and/or movement of the user's eyes. The gaze tracking system may be configured to determine gaze directions of one or both of a user's eyes in any suitable manner. For example, one or more light sources may cause a glint of light to reflect from the cornea of each eye of a user. One or more image sensors may then be configured to capture an image of the user's eyes. Using this information, the gaze tracking system may then determine a direction and/or at what location, physical object, and/or virtual object the user is gazing.

The display device 14 may also include one or more haptic devices that may be utilized to provide feedback to the user 204 in the form of forces, vibrations, and/or motions. The display device 14 may also include a microphone system 92 that includes one or more microphones for capturing audio data. In other examples, audio may be presented to the user via one or more speakers 94 of the display device 14.

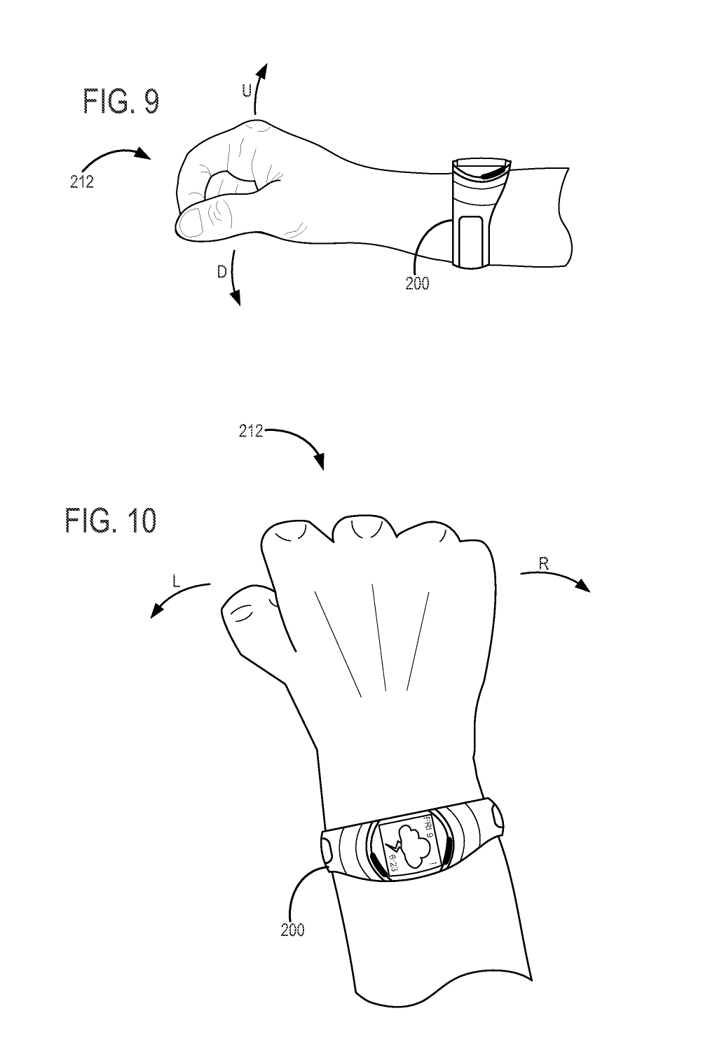

Turning now to FIGS. 9 and 10, examples of the user 204 providing user input to the multi-mode display system 10 via hand movements are illustrated. With reference to FIG. 9, in one example the user 204 may provide user input by bending the user's hand 212 upwardly in the direction of action arrow U or downwardly in the direction of action arrow D. As shown in FIG. 10, the user 204 may also provide user input by bending the user's hand 212 leftwardly in the direction of action arrow L or rightwardly in the direction of action arrow R.

The wristwatch 200 may detect such movements of the user's hand 212 in any suitable manner. In one example, an IMU 80 of the wristwatch 200 may detect such movements. In other examples, one or more image sensor(s) 78 may utilize image data of the user's hand 212 to determine a direction of hand movement. In other examples, a strain gauge 84 may sense such movement via tendon state in the wrist region adjacent to the strain gauge. The strain gauge 84 may also sense other movements related to the user's hand 212 that may correspond to user input, such as a fist-making gesture.

In other examples, the user 204 may provide touch input via touch-sensitive surface(s) 86 located in one or both band portions 816, 818 of the wristwatch 200. In still other examples, data from two or more of the above sensors may be analyzed to determine user input. Additionally, in some examples speech data may be received via microphone system 92 and utilized in combination with one or more of the above sensing methods and technologies to derive user input.

With reference also to FIGS. 2 and 3, in one example movements of the user's hand 212 in the manners illustrated in FIGS. 9 and 10 may be utilized to selectively display different compact images in the first display mode 60, and to navigate within the visual information of an application image in the second display mode 64. For example and as shown in FIG. 2, the user 204 may initially view a weather compact image 208 that is displayed on the wristwatch 200 via the principal image display system 48.

To view a different compact image, the user 204 may provide a principal user input 96 by flicking his hand 212 to the right in the direction of action arrow R. Upon receiving this principal user input 96, the display mode program 22 may display a different compact image corresponding to the same weather application via the principal image display system 48. In some examples, the different compact image may correspond to a different application.

In some examples, two or more compact images may be arranged in a linear, sequential fashion. In these examples, the user 204 may utilize two different hand motions to navigate along the linear arrangement of the compact images. For example, flicking the user's hand 212 to the right displays the compact image located to the right of the current compact image, while flicking the hand to the left displays the compact image located to the left of the current image.

In other examples, compact images may be arranged in a two-dimensional array. In these examples, the user 204 may utilize four different hand motions to navigate among the array of the images. For example, in addition to left and right hand movements, moving the user's hand 212 upwardly in the direction of action arrow U and downwardly in the direction of action arrow D may display compact images located above and below the current image, respectively, in the two-dimensional array.

Additionally, in some examples a predetermined hand motion may correspond to a selection of the currently displayed compact image. For example, the user 204 may select a currently displayed compact image by performing a fist-making gesture. In some examples such selection may trigger the activation of the secondary image display system 52 and the display of the application image corresponding to the currently displayed compact image.

In another example and with reference to FIG. 3, when the secondary image display system 52 is active, the user 204 may navigate within the visual information of the application image that is displayed in the second display mode 64 by providing a secondary user input 98 comprising hand movements. The secondary user input can be used to control a graphical user interface element displayed in the application image. As shown in FIG. 3, in one example a cursor 330 may be displayed and traversed about the visual information of the weather application image 304. For example, when the user 204 moves his hand 212 to the left, right, upwardly, or downwardly as illustrated in FIGS. 9 and 10, a graphical user interface element in the form of cursor 330 may be traversed in corresponding directions within the weather application image 304.

In another example, controlling the graphical user interface element may comprise highlighting a selectable item within the application image. For example and with reference to FIG. 5, while a cursor image may not be visible, in this example the user 204 may navigate within the visual information of the shopping application image 504 by moving his hand 212 in the manner described above to highlight a desired selectable item, such as the apples item 530 in the category detail region 516.

It will also be appreciated that a principal user input 96 and a secondary user input 98 may comprise the same hand movement or gesture. For example, while a leftwardly hand movement may display a different compact image in the first display mode, the same leftwardly hand movement may traverse a cursor leftwardly within an application image in the second display mode 64.

As in the first display mode 60, in some examples a selection input may be provided in the second display mode 64 when the user performs a fist-making gesture. In one example and with reference again to FIG. 3, an area of the map region 312 centered on the location of the cursor 330 may be enlarged when the user performs a fist-making gesture.

It will appreciated that the above-described methods for correlating user hand movements with corresponding navigation and selection among compact images and application images are provided for the purpose of example, and are not intended to be limiting in any manner. Further, it will be understood that in other embodiments, any other suitable movements of a user's hand may be utilized to navigate among compact images or application images, and any other suitable associations between a particular movement and an action to be executed via the display mode program 22 may be utilized.

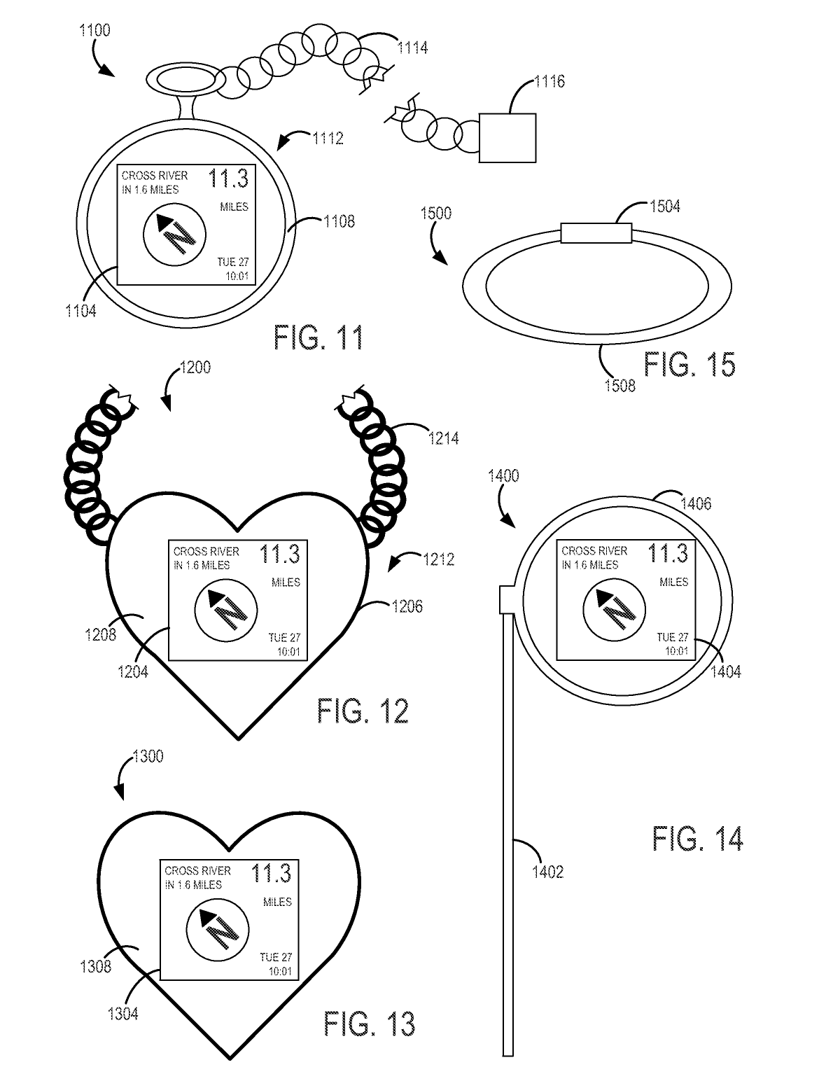

With reference now to FIGS. 11-15, examples of other embodiments of the multi-mode display system 10 in other form factors are presented. It will be appreciated that each of these embodiments may include one or more of the systems, sensors, components and other computing aspects described above. For example, FIG. 11 schematically illustrates the multi-mode display system 10 embodied in a pocket watch 1100. A display 1104 includes a principal image display system and secondary image display system as described above. In some examples, the pocket watch 1100 may include a touch-sensitive surface along one or more portions of its perimeter 1108 and/or on a rear surface of the watch opposite to the display 1104. Such touch surface(s) may be configured to receive user input as described above.

In some examples, the pocket watch 1100 may be configured to house the display 1104, touch-sensitive surface(s) and other interaction components and systems in an active portion 1112. The active portion 1112 may be tethered by a chain 1114 to a passive portion 1116 that may include, for example, a battery or other power source and one or more antennas. In this configuration, a user may hold and interact with the active portion 1112 while the passive portion 1116 may remain in a pocket of an article of clothing.

FIG. 12 schematically illustrates the multi-mode display system 10 embodied in a pendant necklace 1200. A display 1204 may be mounted on the pendant 1206 and includes a principal image display system and secondary image display system as described above. In some examples, the pendant necklace 1200 may include a touch-sensitive surface on a front-facing surface 1208 and/or on a rear surface opposite to the front-facing surface. Such touch surface(s) may be configured to receive user input as described above.

As with the pocket watch 1100, in some examples the pendant necklace 1200 may be configured to house the display 1204, touch-sensitive surface(s) and other interaction components and systems in the pendant 1206 or active portion. The pendant 1206 may be connected by a chain 1214 to a passive portion (not shown) that may be located behind the user's neck when the pendant necklace 1200 is worn. The passive portion may include, for example, a battery or other power source and one or more antennas. In this configuration, a user may hold and interact with the pendant 1206 while the passive portion may remain behind the user's neck.

FIG. 13 schematically illustrates the multi-mode display system 10 embodied in a brooch 1300. A display 1304 includes a principal image display system and secondary image display system as described above. In some examples, brooch 1300 may include a touch-sensitive surface on a front-facing surface 1308 and/or on a rear surface opposite to the front-facing surface. Such touch surface(s) may be configured to receive user input as described above. In some examples, the brooch 1300 may include the touch-sensitive surface(s) and other interaction components and systems, as well as passive components such as, for example, a battery or other power source and one or more antennas.

FIG. 14 schematically illustrates the multi-mode display system 10 embodied in a monocle 1400 that includes a handle 1402. In some examples, a user may grasp the handle 1402 and raise the monocle to the user's eye. A display 1404 may be housed in a viewing portion 1406 and may include a principal image display system and secondary image display system as described above. In some examples, monocle 1400 may include a touch-sensitive surface on one or more portions of the handle 1402. Such touch surface(s) may be configured to receive user input, such as a swiping motion from the user's thumb, or varying amounts of pressure applied by the user's grip.

FIG. 15 schematically illustrates the multi-mode display system 10 embodied in a bracelet 1500. A display 1504 includes a principal image display system and secondary image display system as described above. In some examples, the bracelet 1500 may include a touch-sensitive surface on a rear surface 1508 opposite to the display 1504. Such touch surface(s) may be configured to receive user input, such as from the user's other hand.

It will be appreciated that the embodiments described above are presented for example purposes, and are not intended to be limiting in any manner. Additional embodiments of the present disclosure may include, but are not limited to, the multi-mode display system 10 mounted on top of a cane or walking stick, in a yo-yo, on an outer surface of a purse or wallet, on an underside of a visor on a hat (in which embodiment a user may bend the visor down to switch display modes), on an arm band, on a keychain, or on any other personal item that may be brought close to a user's eye.

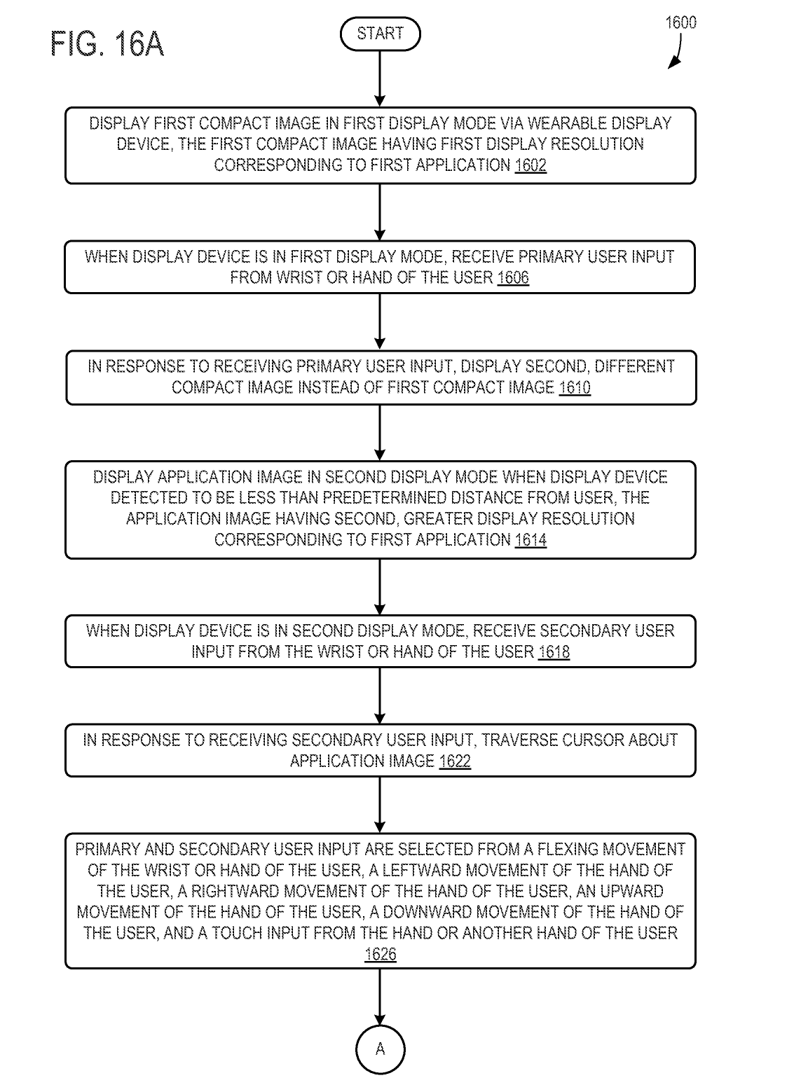

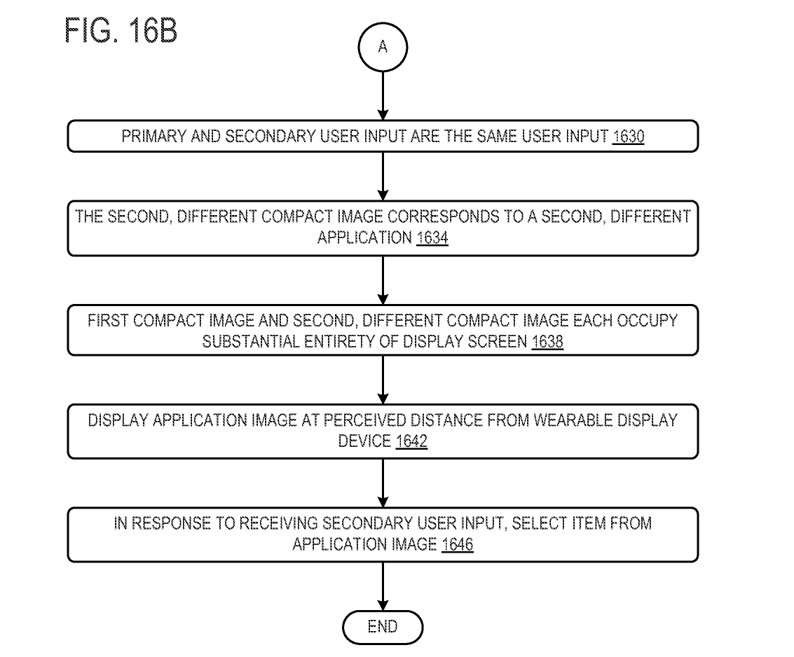

FIGS. 16A and 16B illustrate a flow chart of a multi-mode display method 1600 according to an embodiment of the present disclosure. The following description of method 1600 is provided with reference to the software and hardware components of the wearable multi-mode display system 10 described above and shown in FIGS. 1-15. It will be appreciated that method 1600 may also be performed in other contexts using other suitable hardware and software components.

With reference to FIG. 16A, at 1602 the method 1600 may include displaying a first compact image in a first display mode via a wearable display device, where the first compact image has a first display resolution corresponding to a first application. At 1606 the method 1600 may include, when the display device is in the first display mode, receiving a principal user input from a wrist or hand of the user. At 1610 the method 1600 may include, in response to receiving the principal user input, displaying a second, different compact image instead of the first compact image.

At 1614 the method 1600 may include displaying an application image in a second display mode via the wearable display device when the wearable display device is detected to be less than a predetermined distance from a user, where the application image has a second, greater display resolution corresponding to the first application. At 1618 the method 1600 may include, when the display device is in the second display mode, receiving a secondary user input from the wrist or hand of the user. At 1622 the method 1600 may include, in response to receiving the secondary user input, controlling a graphical user interface element displayed within the application image. For example, the controlling may include traversing a cursor about the application image.

At 1626 the principal user input and the secondary user input may be selected from a flexing movement of the wrist or hand of the user, a leftward movement of the hand of the user, a rightward movement of the hand of the user, an upward movement of the hand of the user, a downward movement of the hand of the user, and a touch input from the hand or another hand of the user. With reference now to FIG. 16B, at 1630 the principal user input and the secondary user input may be the same user input.

At 1634 the second, different compact image may correspond to a second, different application. At 1638 the first compact image and the second, different compact image may each occupy a substantial entirety of the display screen. At 1642 the method 1600 may include displaying the application image at a perceived distance from the wearable display device. At 1646 the method 1600 may include, in response to receiving the secondary user input, selecting an item from the application image.

It will be appreciated that method 1600 is provided by way of example and is not meant to be limiting. Therefore, it is to be understood that method 1600 may include additional and/or alternative steps than those illustrated in FIGS. 16A and 16B. Further, it is to be understood that method 1600 may be performed in any suitable order. Further still, it is to be understood that one or more steps may be omitted from method 1600 without departing from the scope of this disclosure.

FIG. 17 schematically shows a nonlimiting embodiment of a computing system 1700 that may perform one or more of the above described methods and processes. Computing device 18 and application server 40 may take the form of computing system 1700. Computing system 1700 is shown in simplified form. It is to be understood that virtually any computer architecture may be used without departing from the scope of this disclosure. In different embodiments, computing system 1700 may be embodied in or take the form of a wristwatch, pocket watch, pendant necklace, brooch, monocle, bracelet, mobile computing device, mobile communication device, smart phone, gaming device, mainframe computer, server computer, desktop computer, laptop computer, tablet computer, home entertainment computer, network computing device, etc.

As shown in FIG. 17, computing system 1700 includes a logic subsystem 1704 and a storage subsystem 1708. Computing system 1700 may also include a display subsystem 1712, a communication subsystem 1716, a sensor subsystem 1720, an input subsystem 1722 and/or other subsystems and components not shown in FIG. 17. Computing system 1700 may also include computer readable media, with the computer readable media including computer readable storage media and computer readable communication media. Further, in some embodiments the methods and processes described herein may be implemented as a computer application, computer service, computer API, computer library, and/or other computer program product in a computing system that includes one or more computers.

Logic subsystem 1704 may include one or more physical devices configured to execute one or more instructions. For example, the logic subsystem 1704 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem 1704 may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Storage subsystem 1708 may include one or more physical, persistent devices configured to hold data and/or instructions executable by the logic subsystem 1704 to implement the herein described methods and processes. When such methods and processes are implemented, the state of storage subsystem 1708 may be transformed (e.g., to hold different data).

Storage subsystem 1708 may include removable media and/or built-in devices. Storage subsystem 1708 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Storage subsystem 1708 may include devices with one or more of the following characteristics: volatile, nonvolatile, dynamic, static, read/write, read-only, random access, sequential access, location addressable, file addressable, and content addressable.

In some embodiments, aspects of logic subsystem 1704 and storage subsystem 1708 may be integrated into one or more common devices through which the functionally described herein may be enacted, at least in part. Such hardware-logic components may include field-programmable gate arrays (FPGAs), program- and application-specific integrated circuits (PASIC/ASICs), program- and application-specific standard products (PSSP/ASSPs), system-on-a-chip (SOC) systems, and complex programmable logic devices (CPLDs), for example.

FIG. 17 also shows an aspect of the storage subsystem 1708 in the form of removable computer readable storage media 1724, which may be used to store data and/or instructions in a non-volatile manner which are executable to implement the methods and processes described herein. Removable computer-readable storage media 1724 may take the form of CDs, DVDs, HD-DVDs, Blu-Ray Discs, EEPROMs, and/or floppy disks, among others.

It is to be appreciated that storage subsystem 1708 includes one or more physical, persistent devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal via computer-readable communication media.

When included, display subsystem 1712 may be used to present a visual representation of data held by storage subsystem 1708. As the above described methods and processes change the data held by the storage subsystem 1708, and thus transform the state of the storage subsystem, the state of the display subsystem 1712 may likewise be transformed to visually represent changes in the underlying data. The display subsystem 1712 may include one or more display devices utilizing virtually any type of technology. Such display devices may be combined with logic subsystem 1704 and/or storage subsystem 1708 in a shared enclosure, or such display devices may be peripheral display devices. The display subsystem 1712 may include, for example, the display device 14 shown in FIG. 1 and the displays of the various embodiments of the wearable multi-mode display system 10 described above.

When included, communication subsystem 1716 may be configured to communicatively couple computing system 1700 with one or more networks and/or one or more other computing devices. Communication subsystem 1716 may include wired and/or wireless communication devices compatible with one or more different communication protocols. As nonlimiting examples, the communication subsystem 1716 may be configured for communication via a wireless telephone network, a wireless local area network, a wired local area network, a wireless wide area network, a wired wide area network, etc. In some embodiments, the communication subsystem may allow computing system 1700 to send and/or receive messages to and/or from other devices via a network such as the Internet.

Computing system 1700 further comprises a sensor subsystem 1720 including one or more sensors configured to sense different physical phenomenon (e.g., visible light, infrared light, sound, acceleration, orientation, position, strain, touch, etc.). Sensor subsystem 1720 may be configured to provide sensor data to logic subsystem 1704, for example. The sensor subsystem 1720 may comprise one or more image sensors configured to acquire images facing toward and/or away from a user, motion sensors such as accelerometers that may be used to track the motion of the device, strain gauges configured to measure the strain, bend and/or shape of a wrist band, arm band, handle, or other component associated with the device, and/or any other suitable sensors. As described above, such image data, motion sensor data, strain data, and/or any other suitable sensor data may be used to perform such tasks as determining a distance between a user and the display screen of the display subsystem 1712, space-stabilizing an image displayed by the display subsystem 1712, etc.

When included, input subsystem 1722 may comprise or interface with one or more sensors or user-input devices such as a microphone, gaze tracking system, voice recognizer, game controller, gesture input detection device, IMU, keyboard, mouse, or touch screen. In some embodiments, the input subsystem 1722 may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera (e.g. a time-of-flight, stereo, or structured light camera) for machine vision and/or gesture recognition; an eye or gaze tracker, accelerometer and/or gyroscope for motion detection and/or intent recognition; as well as electric-field sensing componentry for assessing brain activity.

The term “program” may be used to describe an aspect of the wearable multi-mode display system 10 that is implemented to perform one or more particular functions. In some cases, such a program may be instantiated via logic subsystem 1704 executing instructions held by storage subsystem 1708. It is to be understood that different programs may be instantiated from the same application, service, code block, object, library, routine, API, function, etc. Likewise, the same program may be instantiated by different applications, services, code blocks, objects, routines, APIs, functions, etc. The term “program” is meant to encompass individual or groups of executable files, data files, libraries, drivers, scripts, database records, etc.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A wearable multi-mode display system actuatable by a wrist or hand of a user, the wearable multi-mode display system comprising a display device operatively connected to a computing device, the wearable multi-mode display system comprising:
a display stack comprising:
a principal image display system including a display screen configured to display a first compact image in a first display mode, the first compact image having a first display resolution corresponding to a first application; and
a secondary image display system configured to display an application image in a second display mode when the display device is detected to be less than a predetermined distance from the user, the application image having a second, greater display resolution corresponding to the first application; and
a display mode program executed by a processor of the computing device, the display mode program configured to:
when the display device is in the first display mode, receive a principal user input from the wrist or hand of the user;
in response to the principal user input, display a second, different compact image instead of the first compact image;
when the display device is in the second display mode, receive a secondary user input from the wrist or hand of the user; and
in response to the secondary user input, control a graphical user interface element displayed in the application image.

2. The wearable multi-mode display system of claim 1, further comprising one or more sensors selected from the group consisting of an image sensor, an accelerometer, a strain gauge, and a touch-sensitive surface.

3. The wearable multi-mode display system of claim 1, wherein the principal user input and the secondary user input are selected from the group consisting of a flexing action of the wrist or hand of the user, a leftward movement of the hand of the user, a rightward movement of the hand of the user, an upward movement of the hand of the user, a downward movement of the hand of the user, and a touch input from the hand or from another hand of the user.

4. The wearable multi-mode display system of claim 1, wherein the principal user input and the secondary user input are the same user input.

5. The wearable multi-mode display system of claim 1, wherein the secondary image display system is positioned on a light emitting side of the principal image display system in the display stack.

6. The wearable multi-mode display system of claim 1, wherein the second, different compact image corresponds to a second, different application.

7. The wearable multi-mode display system of claim 1, wherein the display device has a form factor selected from the group consisting of a wristwatch, pocket watch, bracelet, brooch, pendant necklace, and monocle.

8. The wearable multi-mode display system of claim 1, wherein the display mode program is further configured to switch between the first display mode and the second display mode when the display device is less than the predetermined distance from a user.

9. The wearable multi-mode display system of claim 1, wherein the first compact image and the second, different compact image each occupy a substantial entirety of the display screen.

10. The wearable multi-mode display system of claim 1, wherein the application image is displayed at a perceived distance from the display screen.

11. The wearable multi-mode display system of claim 1, wherein the wearable multi-mode display system is operatively connected to an application server via a network.

12. The wearable multi-mode display system of claim 1, wherein the display mode program is further configured to, in response to the secondary user input, select an item from the application image.

13. A multi-mode display method, comprising:
displaying a first compact image in a first display mode via a wearable display device that is actuatable by a wrist or hand of a user, the first compact image having a first display resolution corresponding to a first application;
when the display device is in the first display mode, receiving a principal user input from the wrist or hand of the user;
in response to receiving the principal user input, displaying a second, different compact image instead of the first compact image;
displaying an application image in a second display mode via the wearable display device when the wearable display device is detected to be less than a predetermined distance from the user, the application image having a second, greater display resolution corresponding to the first application;
when the display device is in the second display mode, receiving a secondary user input from the wrist or hand of the user; and
in response to receiving the secondary user input, control a graphical user interface element displayed in the application image.

14. The method of claim 13, wherein the principal user input and the secondary user input are selected from the group consisting of a flexing movement of the wrist or hand of the user, a leftward movement of the hand of the user, a rightward movement of the hand of the user, an upward movement of the hand of the user, a downward movement of the hand of the user, and a touch input from the hand or another hand of the user.

15. The method of claim 13, wherein the principal user input and the secondary user input are the same user input.

16. The method claim 13, wherein the second, different compact image corresponds to a second, different application.

17. The method of claim 13, wherein the first compact image and the second, different compact image each occupy a substantial entirety of the display screen.

18. The method of claim 13, further comprising displaying the application image at a perceived distance from the wearable display device.

19. The method of claim 13, further comprising, in response to receiving the secondary user input, selecting an item from the application image.

20. A display device removably attachable to a wrist area adjacent to a hand of a user, the display device actuatable by the hand of the user and operatively connected to a computing device, the display device comprising:
a display stack comprising:
a principal image display system including a display screen configured to display a first compact image in a first display mode, the first compact image having a first display resolution corresponding to a first application; and
a secondary image display system positioned on a light emitting side of the principal image display system, the secondary image display system configured to display an application image in a second display mode when the display device is detected to be less than a predetermined distance from an eye of the user, the application image having a second, greater display resolution corresponding to the first application; and
a display mode program executed by a processor of the computing device, the display mode program configured to:
when the display device is in the first display mode, receive a principal user input from the user's hand;
in response to the principal user input, display a second, different compact image instead of the first compact image, wherein the second, different compact image corresponds to a second, different application;
when the display device is in the second display mode, receive a secondary user input from the user's hand; and
in response to the secondary user input, control a graphical user interface element displayed in the application image.
